(19) United States
(12) Patent Application Publication
(10) Pub. No.: US 2005/0289200 A1
(43) Pub. Date: Dec. 29, 2005

(54) Program, electronic device and data processing method

(75) Inventor: Masaaki Miyazawa, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Sony Corporation

(21) Appl. No.: 11/167,261

(22) Filed: Jun. 28, 2005

(30) Foreign Application Priority Data
Jun. 29, 2004 (JP) P2004-191412

(51) Int. Cl. G06F 17/30

(52) U.S. Cl. 707/205

(57) ABSTRACT

A program capable of specifying content data input during a period in accordance with a predetermined condition, by which, when content data is registered in a final folder of newly input management data stored in an SDRAM after a USB interface and a personal computer are disconnected, a CPU handles the content data as new content data and, continuously, creates an empty new folder at the end of newly input management data.

### CROSS REFERENCES TO RELATED APPLICATIONS

The present invention contains subject matter related to Japanese Patent Application JP2004-191412 filed in the Japanese Patent Office on Jun. 29, 2004, the entire contents of which being incorporated herein by reference.

### BACKGROUND OF THE INVENTION

1. Field of the Invention

The present invention relates to a program, an electronic device and a data processing method for managing content data newly input from a provider of the content data.

2. Description of the Related Art

In recent years, due to recording media becoming large in capacity and development of compression techniques for music, moving pictures and still images, etc., it is possible to store enormous amounts of content data in a recording medium in a portable and other type of reproducing apparatus.

Such a reproducing apparatus receives content data, for example, from a personal computer in a state of being connected to the personal computer and stores the same in the recording medium.

In this case, the reproducing apparatus registers the content data input from the computer to the final folder in predetermined management data for managing content data stored in the recording medium.

Also, the reproducing apparatus displays a selection screen of the content data stored in the recording medium in response to an instruction by a user.

There is a demand for displaying a selection screen for selecting only content data newly input from the personal computer during a period after being disconnected from the personal computer in the previous time until disconnected this time.

[Patent Article 1] The Japanese Unexamined Patent Publication No. 2001-76415

### SUMMARY OF THE INVENTION

In the above reproducing apparatus of the related art, content data input from the personal computer is registered in order in the final folder in the above management data and, even when an access to the personal computer is disconnected, the registered content of the final folder is not updated. Also, the reproduction apparatus does not manage time of connecting to the personal computer and time of receiving content data.

Therefore, the above reproducing apparatus of the related art cannot specify whether content data registered in the final folder is what newly input from the personal computer from being disconnected from the personal computer in the previous time until disconnected this time. Consequently, the reproduction apparatus has a disadvantage of being unable to display a selection screen for selecting only content data newly input from the personal computer as explained above.

The disadvantage as above also arises in the case of determining whether it is content data input from the personal computer during a period of fulfilling a predetermined condition other than the case of determining whether it is new content data based on disconnecting from the personal computer.

To solve the disadvantage of the related art explained above, the present invention provides a program, an electronic device and a data processing method for specifying whether or not content data is input during a period in accordance with a predetermined condition when automatically registering the content data input from a provider of the content data to the final folder in management data for managing the content data.

To solve the above disadvantages of the related art explained above, according to a first invention, there is provided an electronic device, comprising an interface for content data to be input from an information provider; a memory means for storing the content data and management data for managing the content data; and a processing means for recording the content data input from the provider via the interface in a newly input folder managed by the management data and, when a predetermined condition is satisfied, managing the content data stored in the newly input folder as content data input from the provider during a period after the predetermined condition is satisfied in the previous time until the condition is satisfied this time.

According to a second invention, there is provided a processing means in an electronic device for receiving content data from a provider and managing the content data, including the steps of receiving content data from an information provider; storing the content data input from the information provider in a newly input folder managed by the management data; and when a predetermined condition is satisfied, managing the content data stored in the newly input folder as content data input from the provider during a period after the predetermined condition is satisfied in the previous time until the condition is satisfied this time.

According to a third invention, there is provided a program executed by an electronic device for receiving content data from a provider and managing the content data, including the routines of receiving content data from an information provider; recording the content data input from the information provider in a newly input folder managed by the management data; and when a predetermined condition is satisfied, managing the content data stored in the newly input folder as content data input from the provider during a period after the predetermined condition is satisfied in the previous time until the condition is satisfied this time.

According to a fourth invention, there is provided an electronic device, comprising: an interface for content data to be input from an information provider; a memory for storing said content data and management data for managing the content data; and a processing circuit for recording said content data input from said provider via said interface in a newly input folder managed by said management data and, when a predetermined condition is satisfied, managing said content data stored in said newly input folder as content data input from said provider during a period after said predetermined condition is satisfied in the previous time until the condition is satisfied this time.

According to the present invention, it is possible to provide a program, an electronic device and a data processing method for specifying content data input during a period in accordance with a predetermined condition in the case of automatically registering content data input from a provider of the content data to the final folder in management data for managing the content data.

### BRIEF DESCRIPTION OF DRAWINGS

These and other objects and features of the present invention will become clearer from the following description of the preferred embodiments given with reference to the attached drawings, in which:

FIG. 1 is a view of the configuration of a reproduction apparatus according to an embodiment of the present invention;

FIG. 2 is a view for explaining an appearance of the reproduction apparatus shown in FIG. 1;

FIG. 3 is a view for explaining management data of song data used by the reproduction apparatus shown in FIG. 1;

FIG. 4 is a view for explaining a screen shift of an LCD panel shown in FIG. 1;

FIG. 5 is a view for explaining a variety of screens displayed on the LCD panel shown in FIG. 1;

FIG. 6 is a view for explaining processing relating to newly input management data performed by a CPU shown in FIG. 1;

FIG. 7 is a view for explaining processing relating to newly input management data performed by the CPU shown in FIG. 1;

FIG. 8 is a view for explaining processing relating to newly input management data performed by the CPU shown in FIG. 1;

FIG. 9 is a flowchart for explaining a first operation example of the reproduction apparatus shown in FIG. 1;

FIG. 10 is a flowchart continued from FIG. 9 for explaining a first operation example of the reproduction apparatus shown in FIG. 1;

FIG. 11 is a flowchart for explaining a second operation example of the reproduction apparatus shown in FIG. 1;

FIG. 12 is a view for explaining shifts of a song select screen displayed on the LCD panel shown in FIG. 1; and

FIG. 13 is a view continued from FIG. 12 for explaining shifts of a song select screen displayed on the LCD panel shown in FIG. 1.

### DESCRIPTION OF THE PREFERRED EMBODIMENT

Below, an embodiment of the present invention will be explained.

A reproduction apparatus according to an embodiment of the present invention will be explained first.

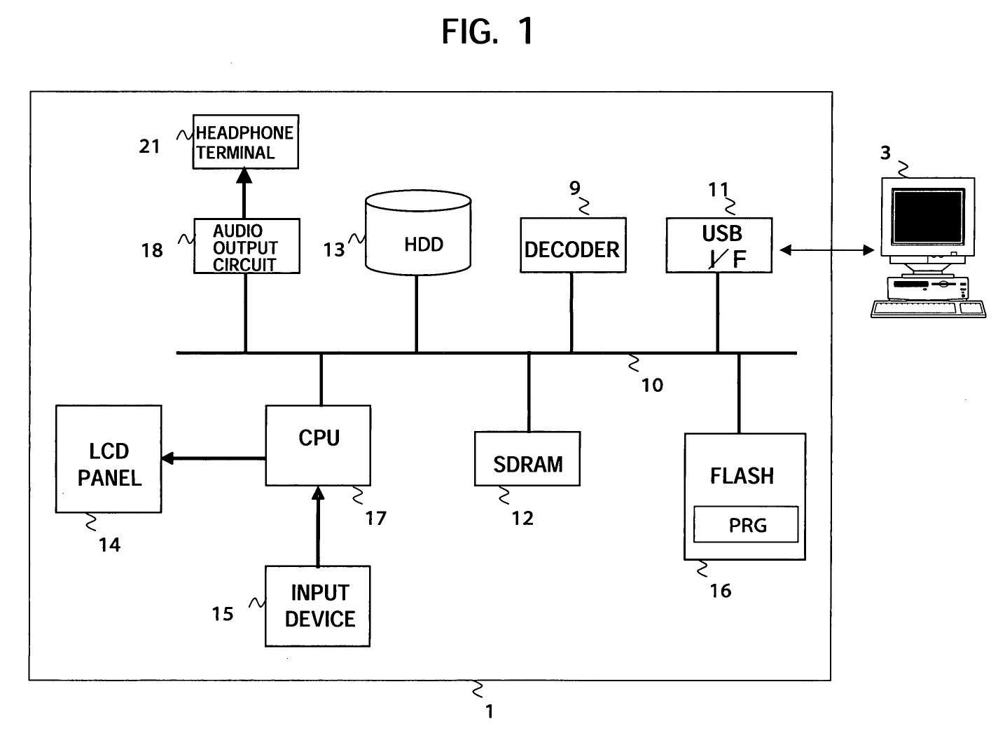

FIG. 1 is a view of the configuration of a reproduction apparatus 1 according to the embodiment of the present invention.

The reproduction apparatus 1 is, for example, a portable audio reproduction apparatus.

As shown in FIG. 1, the reproduction apparatus 1 includes, for example, a decoder 9, a USB (Universal Serial Bus) interface 11, an SDRAM (Synchronous DRAM) 12, an HDD (Hard Disk Drive) 13, an LCD (Liquid Crystal Display) panel 14, an input device 15, a flash memory 16, a CPU (Central Processing Unit) 17 and an audio output circuit 18.

The decoder 9, USB interface 11, SDRAM 12, HDD 13, flash memory 16, CPU 17 and audio output circuit 18 are connected, for example, by a data line 10.

The USB interface 11 is connected to a personal computer 3 and exchanges data with the personal computer 3.

Specifically, song data is input to the USB interface 11 from the personal computer 3.

The SDRAM 12 temporally stores data, etc. relating to processing of the CPU 17.

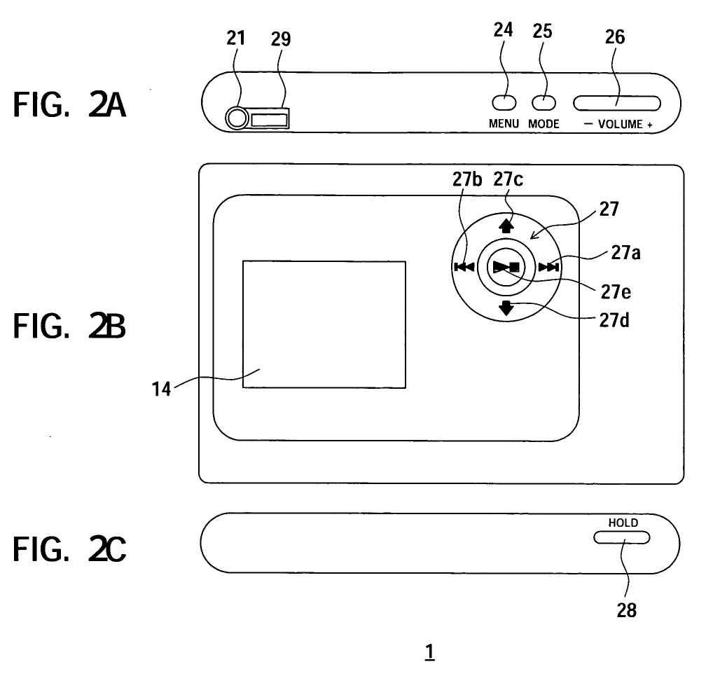

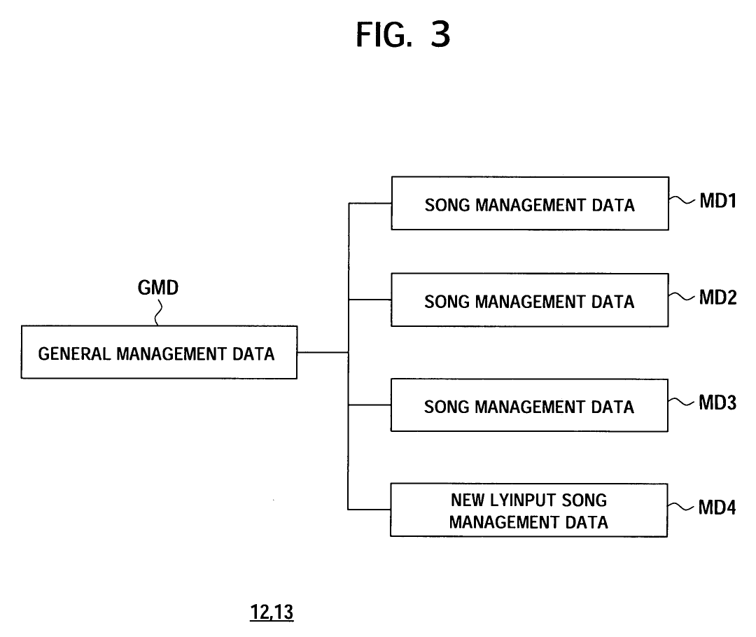

The SDRAM 12 reads, for example, a variety of management data including newly input management data MD4 shown in FIG. 3 from the HDD 13 and stores the same as shown in FIG. 2 to be explained later on.

As shown in FIG. 3, the management data includes song management data MD1, MD2 and MD3, newly input management data MD4 and general management data GMD.

Each of the song management data MD1, MD2 and MD3 and newly input management data MD4 is data for managing song data stored in the HDD 13 based on different rules from one another.

For example, the song management data MD1, MD2 and MD3 are data for managing song data based on name, generated time, artist and album, etc. added to song data stored in the HDD 13.

In the present embodiment, the song management data MD1 has a folder for new songs newly input from the personal computer 3 (newly input song data).

Also, the newly input management data MD4 is data for managing in a list form song data newly input from the personal computer 3 during a period after an access from the reproduction apparatus 1 to the personal computer 3 is switched from a connected state to a disconnected state in the previous time until being switched from a connected state to a disconnected state this time.

The general management data GMD is data for managing the song management data MD1, MD2 and MD3, and newly input management data MD4.

The HDD 13 stores compressed song data (music data).

The song data is written from the personal computer 3 to the HDD 13 via the USB interface 11.

The HDD 13 has a memory capacity of, for example, 20 GB and is capable of storing about 10,000 songs (an amount of 700 compact disks) encoded (compressed) by the ATRAC (Adaptive TRansform Acoustic Coding) 3, etc.

Each song data of an amount of one song (hereinafter, also simply referred to as song data) stored in the HDD 13 is added with attributes data on the artist, album, style, group, new track and book mark, etc.

The LCD panel 14 is, as shown in FIG. 2B, placed on the front surface 1a (a second surface) of a chassis of the reproduction apparatus 1, specifically, on the end portion 1c side with respect to the center of the front surface 1a.

The LCD panel 14 displays a variety of screens by the CPU 17.

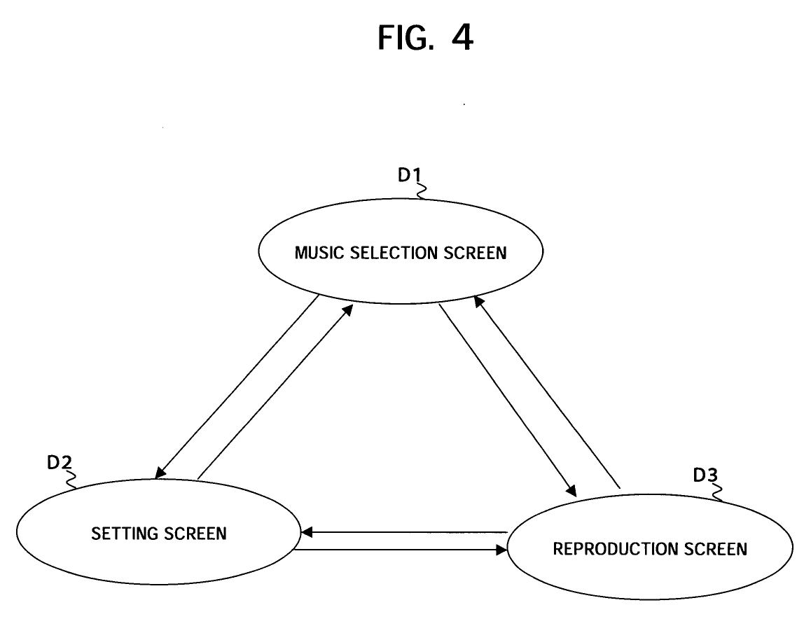

Main screens displayed on the LCD panel 14 are, for example as shown in FIG. 4, a song select screen D1, a setting screen D2 and a reproduction screen D3, and the screens are switched (shifted) in response to a key operation by the user.

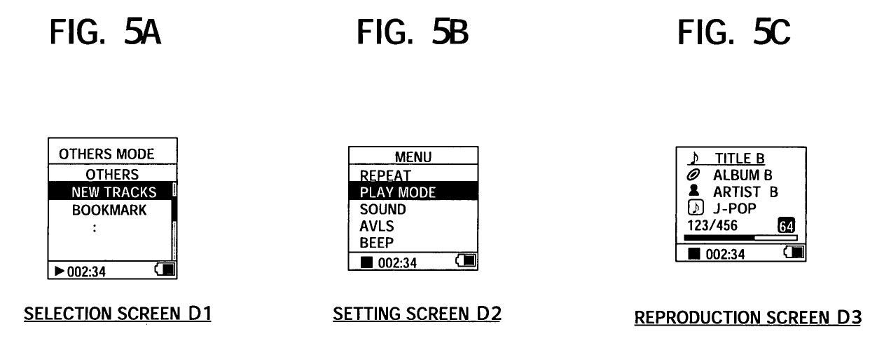

The song select screen D1 displays, for example shown in FIG. 5A, an item (New Tracks) showing names of song data newly input from the personal computer 3, and the user can select the item. The song select screen D1 when the item (New Tracks) shown in FIG. 5A is selected displays as selection items song data registered in the newly input management data MD4, which will be explained later on.

The song select screen D1 is regulated with respect to each of the variety of attributes data and, every time an item is selected, the screen shifts to a song select screen D1 on the lower layer, which will be explained later on.

The setting screen D2 displays, for example as shown in FIG. 5B, items of “Repeat”, “Play Mode”, “Sound”, “AVLS” and “Beep”, etc. The “Play Mode” is specified (selected) when selecting a reproduction mode, which will be explained later on.

Note that by scrolling the setting screen D2 downwardly, other items, such as “Contrast”, “Backlight”, “Reverse Display”, “Language” and “Format”, are displayed on the setting screen D2.

The reproduction screen D3 displays attributes data indicating a title, album, artist and style, etc. of song data selected to be reproduced, and data of a ratio of already reproduced songs, etc.

The input device 15 is provided to the chassis of the reproduction apparatus 1 and is a variety of keys operated by the user.

As the input device 15, for example as shown in FIG. 2A, FIG. 2B and FIG. 2C, there are a remote control terminal 29, a MENU key 24, a MODE key 25, a VOLUME key 26, a cross-shaped key 27 and a HOLD key 28.

The MENU key 24, MODE key 25, VOLUME key 26, cross-shaped key 27 and HOLD key 28 respectively output an operation signal in accordance with an operation, such as pressing, by the user to the CPU 17.

The MENU key 24 is used for displaying the setting screen D2 on the LCD panel 14.

The MODE key 25 is used for displaying and switching the song select screen D1, which will be explained later on. The VOLUME key 26 is used for adjusting the volume regulated by an audio signal output from a headphone terminal 21 to a headphone (not shown).

The VOLUME key 26 has a volume plus key 26a and a volume minus key 26b. The cross-shaped key 27 has a cross right key 27a, a cross left key 27b, a cross upper key 27c, a cross lower key 27d and a cross decision key 27e.

The cross right key 27a and the cross left key 27b are used, for example, when switching layers of the song select screen D1, which will be explained later on.

The cross upper key 27c and the cross lower key 27d are used for moving a cursor upwardly and downwardly on the song select screen D1 and the setting screen D2.

The cross decision key 27e is used for deciding an item pointed by a cursor and inputting a reproduction instruction, etc.

As shown in FIG. 2A, the MENU key 24, MODE key 25, VOLUME key 26, headphone terminal 21 and remote control terminal 29 are provided on a side surface 1d (a first surface of the present invention) in the thickness direction of the chassis of the reproduction apparatus 1.

The MENU key 24, MODE key 25 and VOLUME key 26 are provided in order from the end portion 1b side to the end portion 1b side at the center of the side surface 1d. Here, the end portion 1b positions facing to the end portion 1c. Also, the VOLUME key 26 has a larger area comparing with that of the MENU key 24 and the MODE key 25.

Also, as shown in FIG. 2B, the cross-shaped key 27 is provided on the end portion 1b side with respect to the center of the front surface 1a and on the side surface 1d side.

The flash memory 16 stores, for example, a program PRG regulating an operation of the CPU 17.

The CPU 17 generally controls an operation of the reproduction apparatus 1 based on the program PRG read from the flash memory 16.

The CPU 17 performs processing of managing song data stored in the HDD 13 based on a variety of management data shown in FIG. 3, which will be explained later on.

Also, the CPU 17 performs processing of displaying the song select screen D1, setting screen D2 and reproduction screen D3 on the LCD panel 14.

Also, the CPU 17 reads selected song data from the HDD 13, decodes the same and makes the decoder 9 decode the same.

The audio output circuit 18 outputs an audio signal in accordance with the song data decoded by the decoder 9 to the headphone terminal 21.

Below, processing of managing song data using the management data shown in FIG. 3 by the CPU 17 will be explained.

The processing by the CPU 17 is regulated by the program PRG.

Note that in the processing below, the CPU 17 makes an access to management data read to the SDRAM 12 or management data stored in the HDD 13.

When song data is input from the personal computer 3 via the USB interface 11, the CPU 17 registers the song data in a folder in the management data based on rules of each management data shown in FIG. 2.

Note that processing of registering song data to a folder in the management data is performed by the CPU 17 based on a registration instruction by the personal computer 3 in the present embodiment.

At this time, the CPU 17 registers the song data input from the personal computer 3 to the final folder among folders on a lower layer of a route R of the newly input management data MD4.

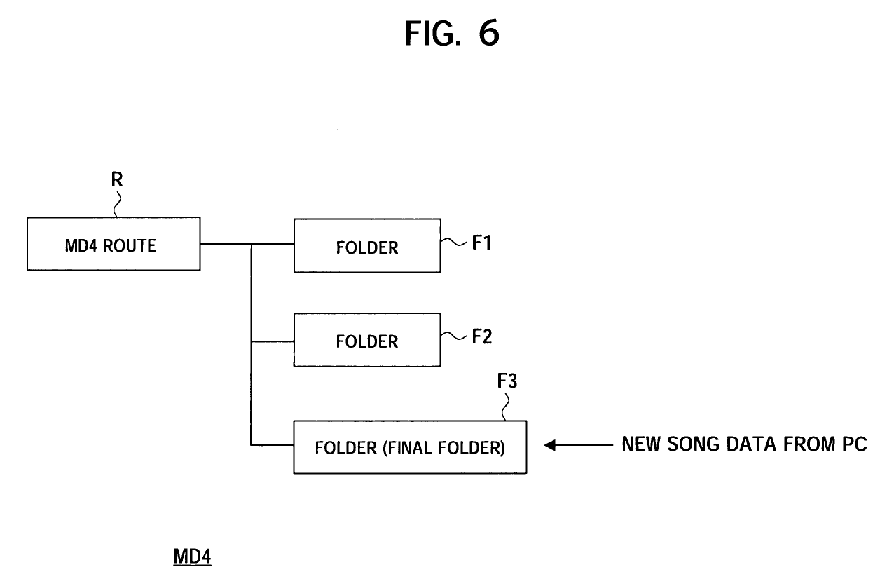

For example, as shown in FIG. 6, when there are folders F1, F2 and F3 on the lower layer of the route R of the newly input management data MD4, the CPU 17 registers the song data input from the personal computer 3 to the final folder F3.

In the present embodiment, the final folder is, for example, a folder having the largest identification number among folders on an immediately lower layer of a route of the newly input management data MD4.

Also, on the condition that the USB interface 11 and the personal computer 3 shown in FIG. 1 are disconnected, newly input management data MD4 exists, and song data is registered in the final folder of the newly input management data MD4, the CPU 17 manages (handles) the song data registered in the final folder as newly input song data. The CPU 17 registers the song data to a new song folder of the song management data MD1.

After that, the CPU 17 creates a new final folder in the newly input management data MD4.

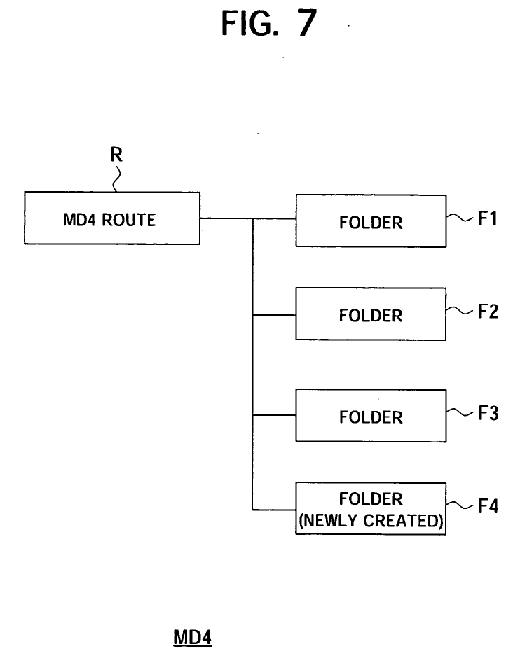

For example, the CPU 17 creates a final folder F4 in the newly input management data MD4 as shown in FIG. 7.

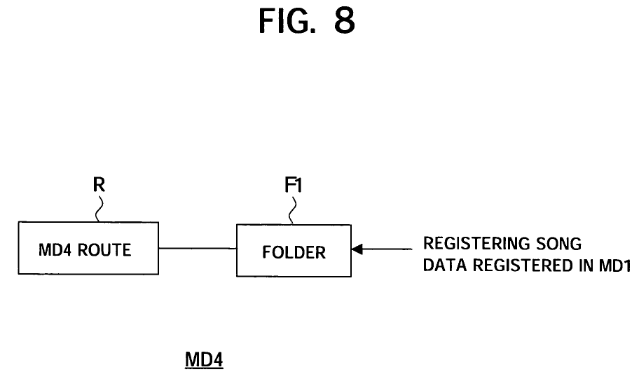

Note that if newly input management data MD4 does not exist when the USB interface 11 and the personal computer 3 shown in FIG. 1 are disconnected, the CPU 17 newly generates newly input management data MD4 including one folder F1 as shown in FIG. 8 and registers in the folder F1, for example, all song data registered in the song management data MD1.

Also, in the case where more than a predetermined number (for example, 6) of folders are already created in newly input management data MD4, the CPU 17 erases a folder created first among the predetermined number of folders when creating a final folder next.

Below, an operation example relating to management of newly input content data by the CPU 17 will be explained.

### FIRST OPERATION EXAMPLE

In this operation example, the case of updating newly input management data MD4 when song data is input from the personal computer 3 to the reproduction apparatus 1 will be explained.

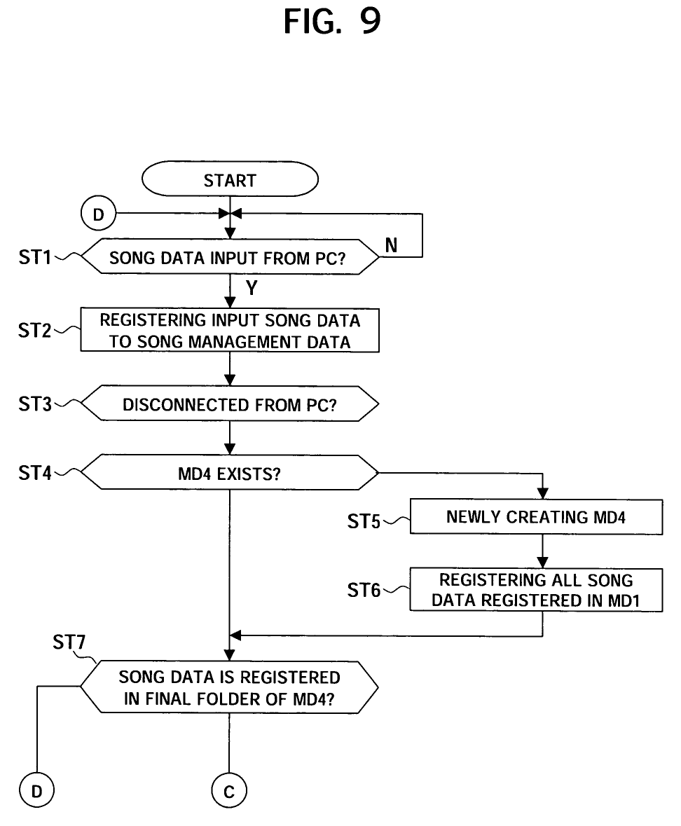

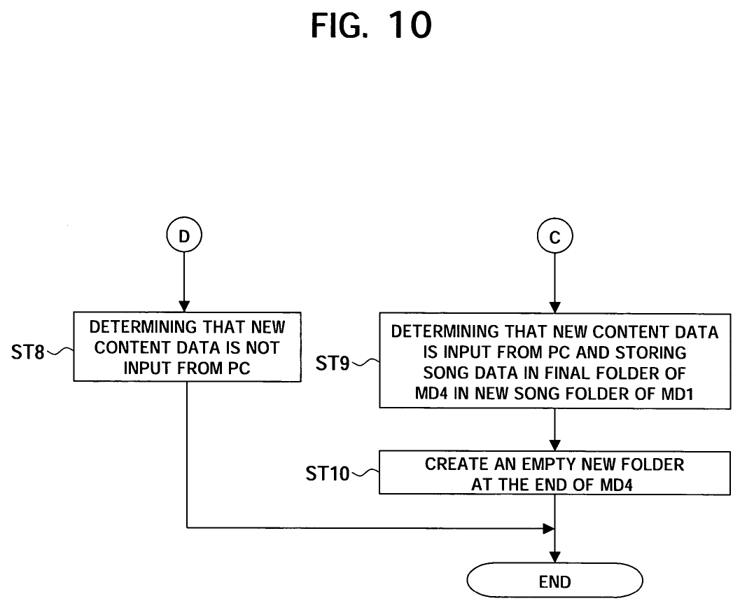

FIG. 9 and FIG. 10 are flowcharts for explaining the operation example.

Note that the processing starts when the reproduction apparatus 1 and the personal computer 3 are in a connected state in the operation example explained below.

Step ST1:

The CPU 17 of the reproduction apparatus 1 shown in FIG. 1 determines whether or not song data is input from the personal computer 3 via the USB interface 11, and proceeds to a step ST2 when determined that it is input, while repeats the determination when determined that it is not input.

Step ST2:

The CPU 17 registers the song data input in the step ST1 to a folder in the management data based on rules of each management data shown in FIG. 3.

At this time, the CPU 17 registers the song data input from the personal computer 3 to the final folder among folders on the lower layer of the route R of the newly input management data MD4.

For example, as shown in FIG. 6, when there are folders F1, F2 and F3 on the lower layer of the route R of the newly input management data MD4, the CPU 17 registers the song data input from the personal computer 3 to the final folder F3.

The processing of registering song data to the final folder F3 in the newly input management data MD4 is performed by the CPU 17 based on a registration instruction by the personal computer 3. Namely, the registration processing is controlled by the personal computer 3.

Step ST3:

The CPU 17 determines whether the USB interface 11 and the personal computer 3 are disconnected or not, and proceeds to a step ST4 when determined that it is disconnected, while repeats the determination when determined that it is not disconnected.

Step ST4:

The CPU 17 determines whether or not newly input management data MD4 is stored (exists) in the HDD 13 or SDRAM 12, and proceeds to a step ST7 when determined that it is stored, while proceeds to a step ST5 when determined that it is not stored.

Step ST5:

The CPU 17 newly generates newly input management data MD4 and writes the same, for example, in the SDRAM 12.

Step ST6:

The CPU 17 registers content data managed by the management data MD1 to the final folder in the newly input management data MD4 generated in the step ST5.

For example, as shown in FIG. 8, the CPU 17 newly generates newly input management data MD4 including one folder F1 in the step ST5 and registers to the folder F1, for example, all song data registered in the song management data MD1.

Step ST7:

The CPU 17 determines whether song data is registered in the final folder of the newly input management data MD4, and proceeds to a step ST9 when determined that it is registered, while proceeds to a step ST8 when determined that it is not registered.

Step ST8:

The CPU 17 determines that new content data is not input from the personal computer 3 during a period after being disconnected from the personal computer 3 in the previous time until disconnection of this time.

Step ST9:

The CPU 17 determines that new content data is input from the personal computer 3 during a period after being disconnected from the personal computer 3 in the previous time until disconnection of this time.

Then, the CPU 17 registers, for example, song data registered in the final folder of the newly input management data MD4 to a new song folder of the song management data MD1.

Step ST10:

The CPU 17 creates an empty new final folder in the newly input management data MD4.

For example, as shown in FIG. 7, the CPU 17 creates a final folder F4 in the newly input management data MD4.

### SECOND OPERATION EXAMPLE

In this operation example, the case of displaying a new song select screen will be explained.

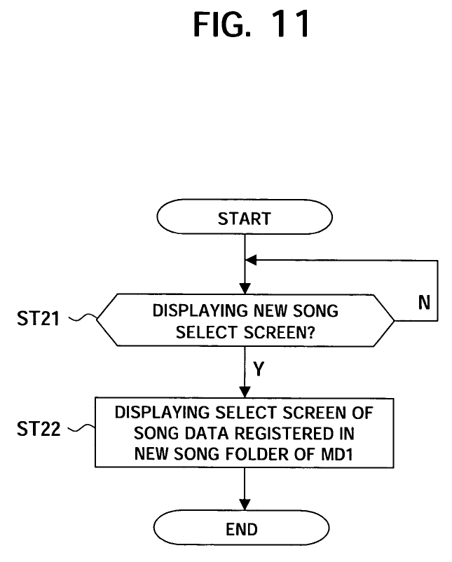

FIG. 11 is a flowchart for explaining the operation example.

Step ST21:

The CPU 17 determines whether or not an instruction of displaying a new song select screen is input from the input device 15, and proceeds to a step ST22 when determined that it is input, while repeats the determination when determined that it is not input.

Step ST22:

The CPU 17 displays on the LCD panel 14 a song select screen including titles of song data registered in the new song folder of the song management data MD1.

Below, the song select screen D1 will be explained.

As the song select screen D1, a plurality of song select screens on a first layer are regulated, which are regulated with respect to each of the plurality of different attributes (attributes of song data) and display a plurality of items regulated by the attributes to select.

Also, as the song select screen D1, song select screens on second and lower layers are regulated for each of the song select screens on the first layer.

The song select screens on second and lower layers are regulated with respect to each item of the song select screens on its upper layer and has a plurality of items for classifying song data belonging to the item based on the attributes other than the above attributes corresponding to the items.

First, a song select screen D1 on the first layer will be explained.

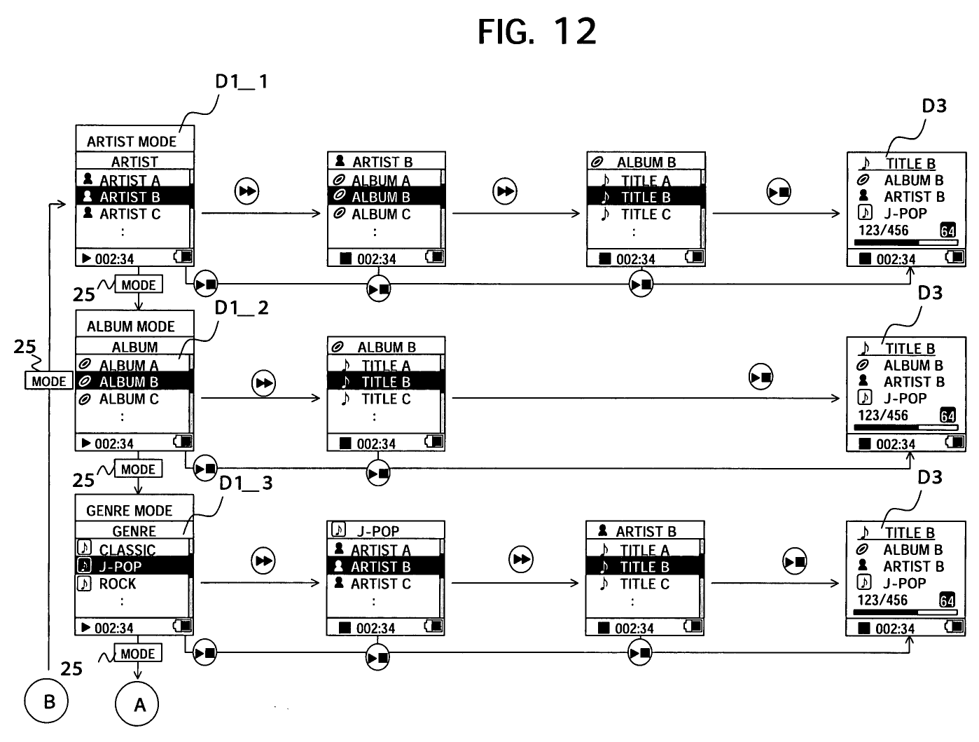

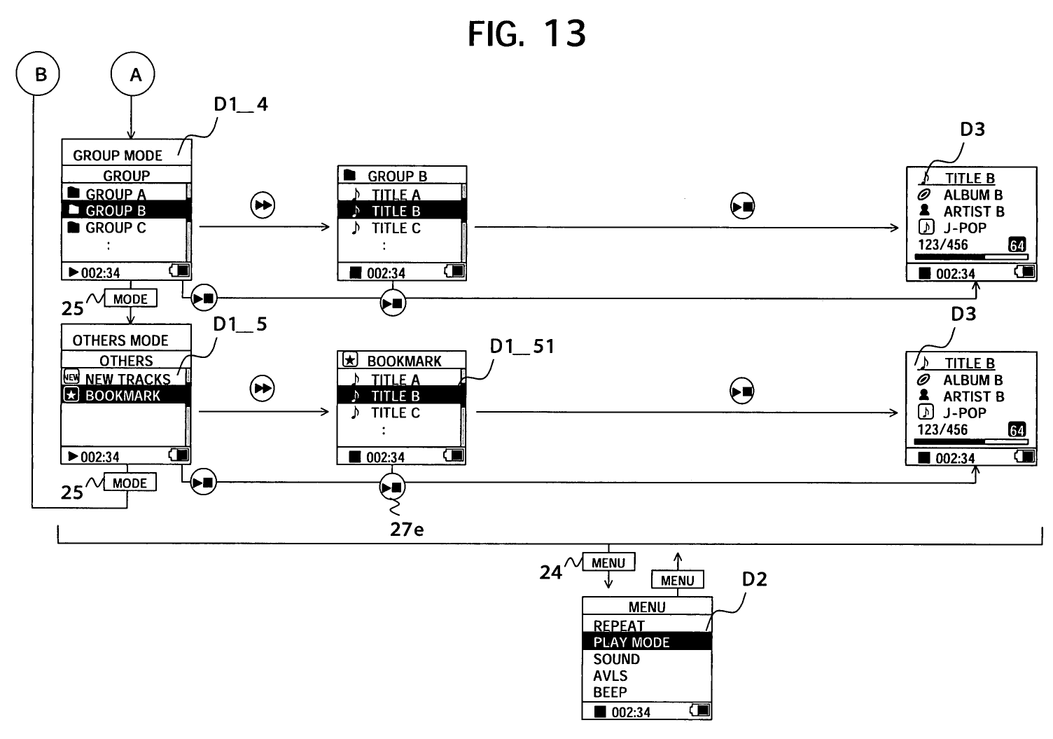

The song select screen D1 on the first layer is, for example, song select screens D1_1, D1_2, D1_3, D1_4 and D1_5 shown in FIG. 12 and FIG. 13.

Here, the song select screens D1_1, D1_2, D1_3, D1_4 and D1_5 are screens for displaying by classifying song data based on attributes thereof: an Artist, Album, Style, Group and Others, respectively.

For example, when a user presses the MODE key 25 shown in FIG. 2A in a state where the setting screen D2, etc. is displayed on the LCD panel 14, the CPU 17 shown in FIG. 1 displays the song select screen D1_1 shown in FIG. 12 on the LCD panel 14 based on an operation signal from the MODE key 25.

The song select screen D1_1 displays a plurality of items (artists A, B and C, etc.) for classifying the song data based on an attribute of artists.

At this time, the CPU 17 may display a song select screen on the first layer other than the song select screen D1_1 on the LCD panel 14.

Continuously, when the user presses the MODE key 25, the CPU 17 displays the song select screen D1_2 shown in FIG. 12 on the LCD panel 14 based on an operation signal from the MODE key 25.

The song select screen D1_2 displays a plurality of items (albums A, B and C, etc.) for classifying the song data based on an attribute of albums.

Continuously, when the user presses the MODE key 25, the CPU 17 displays the song select screen D1_3 shown in FIG. 12 on the LCD panel 14 based on an operation signal from the MODE key 25.

The song select screen D1_3 displays a plurality of items (CLASSIC, J-POP and ROCK, etc.) for classifying the song data based on an attribute of styles.

Continuously, when the user presses the MODE key 25, the CPU 17 displays the song select screen D1_4 shown in FIG. 13 on the LCD panel 14 based on an operation signal from the MODE key 25.

The song select screen D1_4 displays a plurality of items (groups A, B and C, etc.) for classifying the song data based on an attribute of groups regulated by the personal computer 3.

Continuously, when the user presses the MODE key 25, the CPU 17 displays the song select screen D1_5 shown in FIG. 13 on the LCD panel 14 based on an operation signal from the MODE key 25.

The song select screen D1_5 displays a plurality of items for classifying the song data based on other attributes, such as “New Tracks” indicating newly input tracks (song data) from the personal computer 3 and “Bookmark” indicating that a bookmark is put by the user.

Continuously, when the cross right key 27a is pressed on the song select screen D1_5, the CPU 17 displays the song select screen D1_51 showing titles of song data registered in the new song folder of the song management data MD1 as explained above.

Continuously, when a cursor is moved vertically on the song select screen D1_51 to point a desired title and a cross decision key 27e is pressed, the CPU 17 displays a reproduction screen D3 of the title on the LCD panel 14 and reproduces the same.

As explained above, according to the reproduction apparatus 1, as explained by using FIG. 9 and FIG. 10, when content data is registered in the final folder of the newly input management data MD4 after being disconnected from the personal computer 3, the content data is handled as new content data and, continuously, an empty new final folder is created in the newly input management data MD4.

As a result, in the reproduction apparatus 1, only content data newly input from the personal computer during a period after being disconnected from the personal computer in the previous time until disconnecting this time is registered in the final folder of the newly input management data MD4.

Therefore, the reproduction apparatus 1 is capable of specifying that the content data registered in the final folder of the newly input management data MD4 is content data newly input from the personal computer during a period after being disconnected from the personal computer in the previous time until disconnecting this time. As a result, the reproduction apparatus 1 is capable of displaying on the LCD panel 14 a song select screen for selecting the specified newly input content data.

The present invention is not limited to the above embodiment.

In the above embodiment, the case of applying the present invention to a portable audio reproduction apparatus was explained as an example, but the present invention can be applied to apparatuses other than portable types, such as a personal computer.

Also, in the above embodiment, the case where the reproduction apparatus 1 and the personal computer 3 were disconnected was explained as an example of a predetermined condition of the present invention, but the condition may be, for example, a certain time interval, an input of an instruction by a user, and inputting of a predetermined number of content data, etc.

Also, in the above embodiment, audio data, such as song data, was explained as an example of content data of the present invention, but it may be image data, such as a video and picture.

Also, in the above embodiment, a portable audio reproduction apparatus was explained as an example of the reproduction apparatus 1, but the reproduction apparatus 1 may be a personal computer, an optical disk reproduction apparatus and a magneto-optical disk reproduction apparatus, such as a compact disk, etc.

The present invention can be applied to a system for managing content data newly input from a provider of the content data.

It should be understood by those skilled in the art that various modifications, combinations, sub-combinations and alternations may occur depending on design requirements and other factors insofar as they are within the scope of the appended claims or the equivalents thereof.

1. An electronic device, comprising:
an interface for content data to be input from an information provider;
a memory means for storing said content data and management data for managing the content data; and
a processing means for recording said content data input from said provider via said interface in a newly input folder managed by said management data and, when a predetermined condition is satisfied, managing said content data stored in said newly input folder as content data input from said provider during a period after said predetermined condition is satisfied in the previous time until the condition is satisfied this time.

2. An electronic device as set forth in claim 1, wherein, when a predetermined condition is satisfied, said processing means manages said content data stored in said newly input folder as content data input from said provider during a period after said predetermined condition is satisfied in the previous time until the condition is satisfied this time, and newly creates a newly input folder.

3. An electronic device as set forth in claim 2, wherein, when a predetermined condition is satisfied again, said processing means stores said content data input from said provider via said interface in a new newly input folder to be managed by said new management data.

4. An electronic device as set forth in claim 1, wherein said newly input folder is a final folder created finally in said electronic device.

5. An electronic device as set forth in claim 1, wherein said processing means stores said content data input from said provider via said interface in a newly input folder managed by said management data and, when disconnection from said provider is detected, manages said content data stored in said newly input folder as content data input from said provider during a period after being disconnected from said provider in the previous time until disconnected from said provider this time.

6. An electronic device as set forth in claim 1, wherein:
said management data comprises a plurality of management data for managing content data based on different rules from one another and newly input management data; and
said processing means stores said content data input from said provider via said interface in a newly input folder managed by said newly input management data and, when a predetermined condition is satisfied, manages said content data stored in said newly input folder as content data input from said provider during a period after said predetermined condition is satisfied in the previous time until the condition is satisfied this time, and makes the content data managed by said plurality of management data based on said rules.

7. An electronic device as set forth in claim 6, wherein said processing means determines whether said newly input management data exists or not when retrieving said content data from said provider via said interface, newly generates said newly input management data when determined that the newly input management data does not exist, and registers content data managed by said plurality of management data to a newly input folder managed by the newly generated newly input management data.

8. An electronic device as set forth in claim 7, wherein said processing means stores said content data input from said provider via said interface and, when a predetermined condition is satisfied, manages said content data stored in said newly input folder as content data input from said provider during a period after said predetermined condition is satisfied in the previous time until the condition is satisfied this time, and records content data stored in said newly input folder in a folder managed by other management data.

9. An electronic device as set forth in claim 8, further comprising a display means for displaying content data managed by said management data; wherein
said processing means makes said display means display content data stored in said folder.

10. An electronic device as set forth in claim 9, further comprising a reproduction means for reproducing said content data;
wherein when a display of content data displayed by said display means is selected, said processing means reproduces the selected content data.

11. A processing means in an electronic device for receiving content data from a provider and managing the content data, including the steps of:
receiving content data from an information provider;
storing said content data input from said information provider in a newly input folder managed by said management data; and
when a predetermined condition is satisfied, managing said content data stored in said newly input folder as content data input from said provider during a period after said predetermined condition is satisfied in the previous time until the condition is satisfied this time.

12. A program executed by an electronic device for receiving content data from a provider and managing the content data, including the routines of:
receiving content data from an information provider;
recording said content data input from said information provider in a newly input folder managed by said management data; and
when a predetermined condition is satisfied, managing said content data stored in said newly input folder as content data input from said provider during a period after said predetermined condition is satisfied in the previous time until the condition is satisfied this time.

13. An electronic device, comprising:
an interface for content data to be input from an information provider;
a memory for storing said content data and management data for managing the content data; and
a processing circuit for recording said content data input from said provider via said interface in a newly input folder managed by said management data and, when a predetermined condition is satisfied, managing said content data stored in said newly input folder as content data input from said provider during a period after said predetermined condition is satisfied in the previous time until the condition is satisfied this time.
